(19) United States
(12) Patent Application Publication
(10) Pub. No.: US 2012/0236759 A1
(43) Pub. Date: Sep. 20, 2012

(54) WIMAX CUSTOMER PREMISES EQUIPMENT AND METHOD FOR SETTING PARAMETER IDENTITIES THEREOF

(75) Inventor: CHENG-YI HUANG, Tu-Cheng (TW)

(73) Assignee: HON HAI PRECISION INDUSTRY CO., LTD., Tu-Cheng (TW)

(21) Appl. No.: 13/197,787

(22) Filed: Aug. 4, 2011

(30) Foreign Application Priority Data
Mar. 14, 2011 (CN) 201110060510.4

(51) Int. Cl. H04W 84/00

(52) U.S. Cl. 370/256

(57) ABSTRACT

A method for setting parameter identities of a worldwide interoperability for microwave access (WIMAX) customer premises equipments (CPE) which includes a plurality of parameter groups and a plurality of critical parameter groups correspondingly, each critical parameter group includes a plurality of critical parameter identities correlative to each other. The WIMAX CPE receives a setting package from a server and determines whether the setting package contains critical parameter identities of a critical parameter group. If the setting package contains critical parameter identities of the critical parameter group, the WIMAX CPE determines whether the setting package contains all critical parameter identities of the critical parameter group. If the setting package misses at least one critical parameter identities of the critical parameter group, the WIMAX CPE waits to receiving the missing critical parameter identities until receiving all critical parameter identities of the critical parameter group.

### BACKGROUND

1. Technical Field

The disclosure generally relates to Worldwide Interoperability for Microwave Access (WIMAX) customer premises equipments (CPE) and method for setting parameter identities of the equipment, particularly to a method for setting parameters of WIMAX CPEs using Open Mobile Alliance Device Management (OMA-DM) protocol.

2. Description of Related Art

OMA-DM protocol is a device management protocol constituted by the Open Mobile Alliance. WIMAX CPEs download operational commands from a remote DM server via OTA (Over the air) technology using the OMA-DM protocol, and execute the operational commands to implement various management functions, such as firmware update, parameters and settings configuration, data collection, and diagnosis. Each WIMAX CPE has a management tree which is used to manage parameter identities of the WIMAX CPE correspondingly managed by the DM server.

DM servers can set and update parameters of the WIMAX CPEs using the OMA-DA protocol in real time. Some critical parameter identities of the WIMAX CPE are correlated to each other, if even one parameter identity of these correlative parameter identities has not been set properly or updated, the WIMAX CPE will run in error.

### BRIEF DESCRIPTION OF THE DRAWINGS

Many aspects of the exemplary WIMAX CPE and method can be better understood with reference to the following drawings. These drawings are not necessarily drawn to scale, the emphasis instead being placed upon clearly illustrating the principles of the present WIMAX CPE and method. Moreover, in the drawings like reference numerals designate corresponding parts throughout the several views. Wherever possible, the same reference numbers are used throughout the drawings to refer to the same or like elements of an embodiment.

FIG. 1 shows a WIMAX CPE 10 in communication with a server of a communication service provider via a network, according to an exemplary embodiment.

FIG. 2 is a schematic block diagram of an exemplary WIMAX CPE.

FIG. 3 schematically illustrates a management tree and several parameter groups of an application module according to an exemplary embodiment.

FIG. 4 is a schematic flowchart of an exemplary method for setting parameters of a WIMAX CPE.

### DETAILED DESCRIPTION

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or other computer storage device. Some non-limiting examples of non-transitory computer-readable mediums include DVDs, CDs, and hard disk drives.

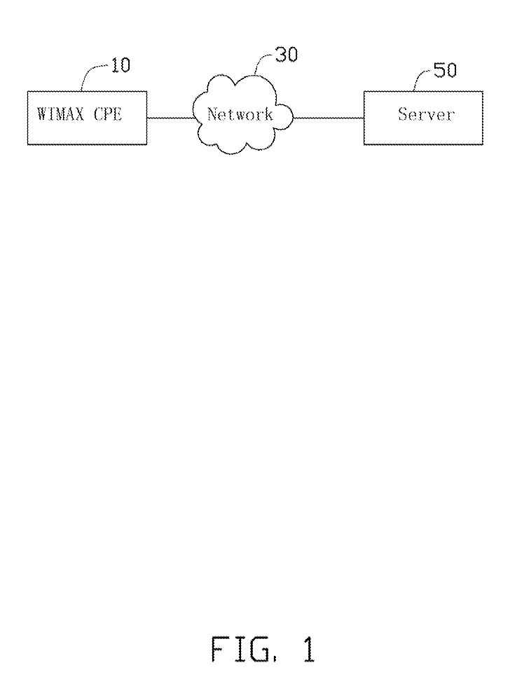

FIG. 1 shows a WIMAX CPE 10 in communication with a server 50 of a communication service provider via a network 30, according to an exemplary embodiment. The WIMAX CPE 10 downloads operational commands from the server 50 using the OMA-DM to procure services. The network 30 can be an intranet, the Internet, a WAN (wide area network), a LAN (local area network), or cellular telephone network such as GSM (global System for mobile communication) network, CDMA (code division multiple access) network, or other communication network such as an IEEE 802.16 (WIMAX) network, or an IEEE 802.11x (WiFi) network.

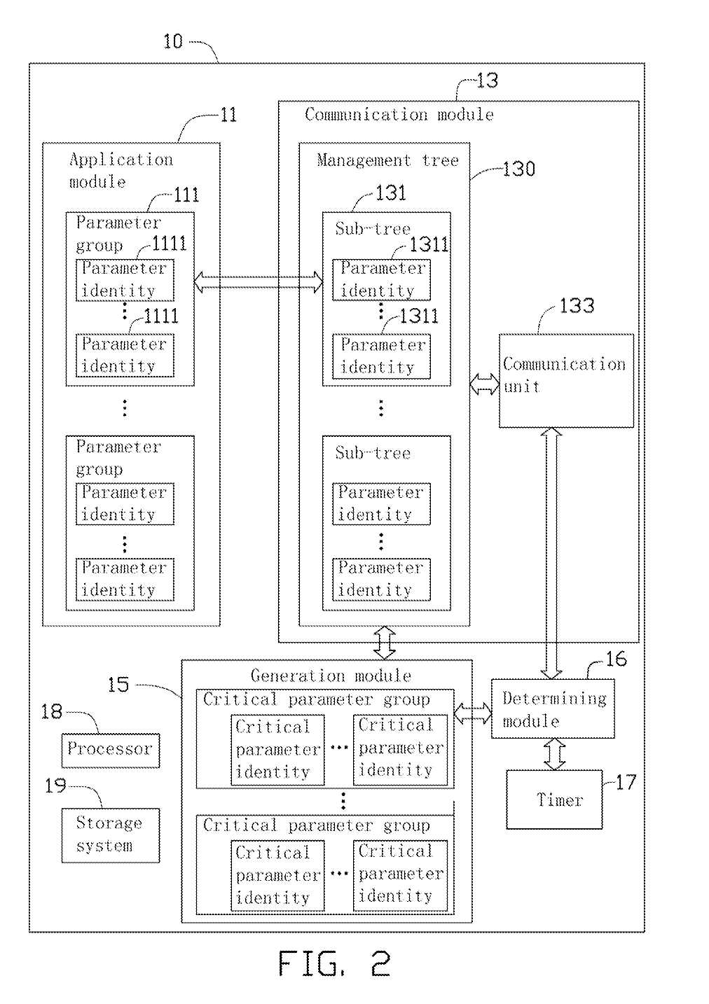

FIG. 2 shows an exemplary WIMAX CPE 10 which includes an application module 11, a communication module 13, a generation module 15, a determining module 16, and a timer 17. The communication module 13 receives setting packages from the server 50, and assigns the values of parameter identities in the setting packages to the application module 11. The WIMAX CPE 10 further includes a processor 18 and a storage system 19. The processor 18 executes one or more computerized operations of the WIMAX CPE 10 and other software applications, to implement basic functions of the WIMAX CPE 10. The storage system 19 stores at least one program, such as an operating system, and other software applications of the WIMAX CPE 10. The application module 11 can be integrated in the storage system 19. The modules 13, 15, 16 and timer 17 each includes at least one computerized code stored in the storage system 19 to be executed by the processor 18 to perform corresponding operations of the WIMAX CPE 10. Details of these operations will be provided below.

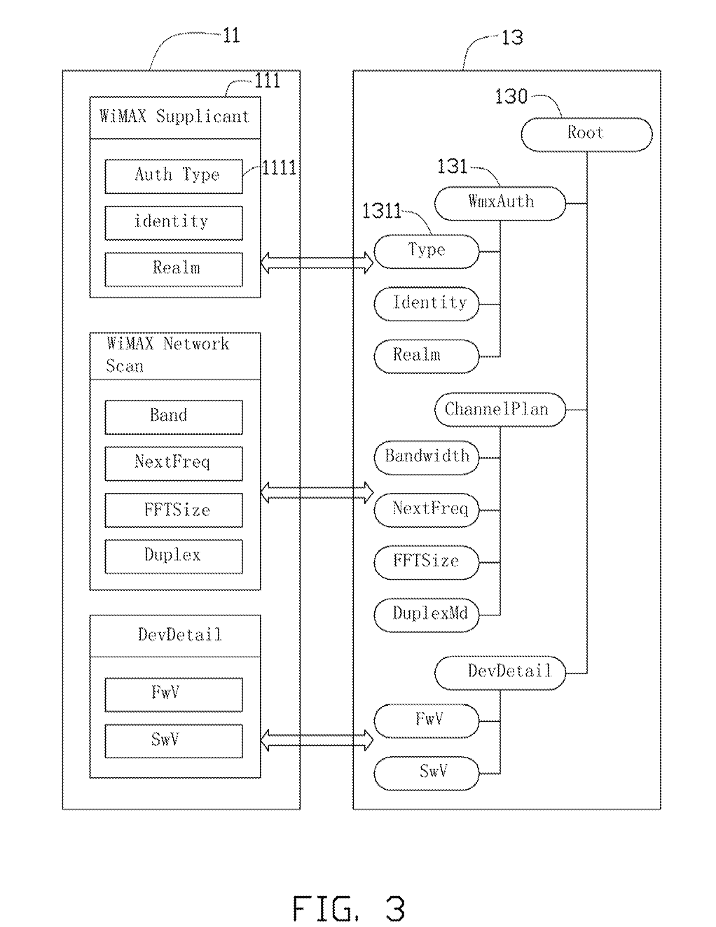

The application module 11 includes several software components (not shown). Each software component has a corresponding parameter group 111 which includes a plurality of parameter identities 1111. The server 50 managements the software components by setting and updating the values of the parameter identities 1111 of the corresponding parameter group 111. Referring FIG. 3, the parameter groups 111 include but are not limited to parameter groups named WiMAX Supplicant, WiMAX Network Scan, and DevDetail. The parameter group WiMAX Supplicant includes three parameter identities 1111 named Auth Type, identity, and Realm respectively. The parameter group WiMAX Network Scan includes four parameter identities 1111 named Band, NextFreq, FFTSize, and Duplex respectively. The parameter group DevDetail includes two parameter identities 1111 named FwV and SwV respectively. Each parameter identity 1111 has a corresponding value.

The communication module 13 includes a management tree 130 and a communication unit 133. The management tree 130 is constructed according to the structure of the parameter groups 111 of the application module 11. The management tree 130 includes a plurality of sub-trees 131 which are constructed in a manner corresponding to the parameter groups 111. Each sub-tree 131 includes a plurality of parameter identities 1311. Each sub-tree 131 and the corresponding parameter group 111 may have a different name, but substantially consist of the same parameter identities. The parameter identities 1311 of the sub-tree 131 and the corresponding parameter identities 1111 of the parameter group 111 may also have different names, but have the same values. For example, the sub-trees 131 include sub-trees named WmxAutch, ChannelPlan, and DevDetail which respectively correspond to the parameter groups WiMAX Supplican, WiMAX Network Scan, and DevDetail. The parameter identities 1311 include parameter identities named Bandwidth, NextFreq, FFTSzie, and DuplexMd of the sub-tree ChannelPlan which respectively correspond to the parameter identities Band, NextFreq, FFTSize, and Duplex of the parameter group WiMAX Network Scan. The parameter identities FwV and SwV of the sub-tree DevDetail respectively correspond to the parameter identities FwV and SwV of the parameter group DevDetail.

The communication unit 133 communicates with the server 50 via the network 30, and receives setting packages from the server 50. The server 50 transmits the setting packages to the WIMAX CPE 10 to set and update values of the parameter identities of the WIMAX CPE 10 using OMA-DM protocol. The setting packages contain related information of the parameter groups 111 needing to be configured, parameter identities 1111 of the parameter groups 111 and values of the parameter identities 1111. The values of the parameter identities 1111 in the setting packages are assigned to the parameter identities 1311 by the server 50, and are then assigned to the parameter identities 1111 by the management tree 130.

The generation module 15 is used to generate critical parameter groups. When some of the parameter identities 1311 of the sub-tree 131 are correlated to each other, the generation module 15 generates a critical parameter group including all correlative parameter identities 1311 of the sub-tree 131, and the correlative parameter identities are defined as critical parameter identities. For example, the parameter identities Type, Identity, and Realm of the sub-tree WmxAuth are correlated to each other, so the generation module 15 generates a critical parameter group including the parameter identities Type, Identity, and Realm of the sub-tree WmxAuth. The critical parameter groups can be generated by the generation module 15 according to the correlative parameter identities of the sub-tree 131, and the critical parameter groups can also be formed by labeling the correlative parameter identities of the sub-tree 131 as critical parameter identities of critical groups by the generation module 15. In the exemplary embodiment, the critical parameter groups are generated by the generation module 15 according to the correlative parameter identities of the sub-tree 131. If the sub-tree 131 corresponding to a critical parameter group configured by the server 50 includes correlative parameter identities (critical parameter identities), all correlative parameter identities (critical parameter identities) should be configured so the software component can execute correct operations corresponding to the sub-tree 131.

The determining module 16 is used to determine whether the setting packages transmitted by the server 50 are for configuring critical parameter groups. When one setting package contains at least one critical parameter identity of one critical parameter group, the determining module 16 further determines whether the setting package contains all critical parameter identities of the corresponding critical parameter group. If the setting package contains all critical parameter identities of the critical parameter group, the sub-tree 131 corresponding to the critical parameter group communicates with the parameter group 111 and assigns the values to the parameter identities 1111. Otherwise, if the setting package is missing one or more critical parameter identities of the critical parameter group, the timer 17 starts timing, and the communication unit 133 waits to receiving another setting package which contains the missing critical parameter identity (identities). If the communication unit 133 has not received the missing critical parameter identity (identities) when time is up according to the timer 17, the communication unit 133 transmits a feedback package indicating the missing critical parameter identity (identities) to the server 50, and requests the server 50 to transmit the missing critical parameter identity (identities). In addition, if the setting packages do not contain any critical parameter identities, the communication unit 133 assigns the value contained in the setting package to the parameter identities 1311 of the sub-tree 131 collectively, and then the sub-tree 131 assigns the value to the parameter identities 1111 of the parameter group 111 collectively.

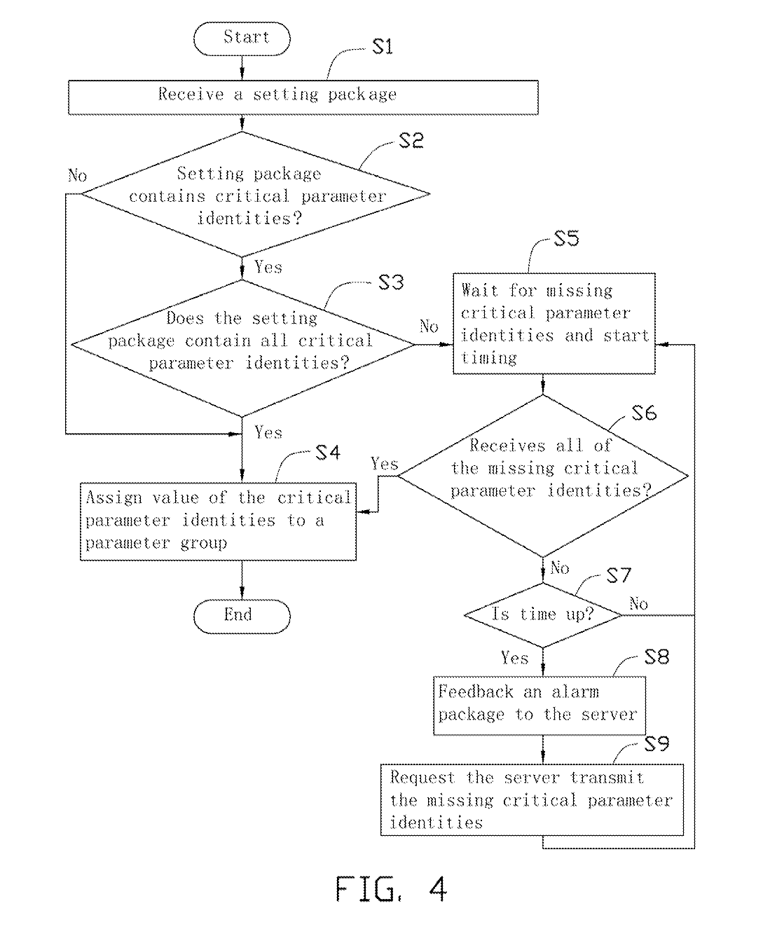

FIG. 4 is a schematic flowchart of an exemplary method for setting parameter identities of a WIMAX CPE of FIG. 2, according to the exemplary embodiment. Depending on the embodiment, additional blocks may be added, others removed, and the ordering of the blocks may be changed.

Step S1, the communication unit 133 receives a setting package from the server 50. The setting package contains related information of parameter groups that need to be configured, parameter identities of the parameter groups, and values of the parameter identities.

Step S2, the determining module 16 determines whether the setting package contains critical parameter identities of a critical parameter group. If the setting package contains at least one critical parameter identities of a critical parameter group, Step S3 is executed. Otherwise, if the setting package does not contain any critical parameter identities, Step S4 is executed.

Step S3, the determining module 16 determines whether the setting package contains all critical parameter identities of the critical parameter group. If the setting package contains all critical parameter identities of the critical parameter group, Step 4 is executed. Otherwise, if the setting package is missing at least one critical parameter identity of the critical parameter group, Step S5 is executed.

Step S4, the communication unit 133 assigns the values of the critical parameter identities to the parameter group 111. The communication unit 133 assigns the values contained in the setting package to the parameter identities 1311 of the sub-tree 131 collectively, and then the sub-tree 131 assigns the values to the parameter identities 1111 of the parameter group 111 collectively.

Step S5, the communication unit 133 assigns the values of the parameter identities contained in the setting package to the parameter identities 1311 of the sub-tree 131 correspondingly, and waits to receive the missing critical parameter identity (identities) of the critical parameter group, meanwhile the timer 17 starts timing to restrict waiting time of the communication unit 133.

Step S6, The determining module 16 determines whether the communication unit 133 has received all of the missing critical parameter identity (identities). If the communication unit 133 has received the missing critical parameter identity (identities), the procedure returns to step S4. Otherwise, if the communication unit 133 does not receive the missing critical parameter identity (identities), Step S7 is executed.

Step S7, the determining module 16 determines whether time is up according to the timer 17. If waiting time is up, Step S8 is executed, otherwise, if the timer 17 still timing, the procedure returns to Step S5.

Step S8, the sub-tree 131 does not assign the value of the critical parameter identities to the parameter 1111, and the communication unit 133 feeds back a alarm package to the server 50 to notify the server 50 of parameter setting failure.

Step S9, the communication unit 133 transmits a feedback package indicating the missing critical parameter identity (identities) to the server 50, and requests the server 50 to transmit the missing critical parameter identity (identities) thereto. The procedure returns to Step S6.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A worldwide interoperability for microwave access (WIMAX) customer premises equipments (CPE), comprising:
at least one processor;
a storage system; and
one or more modules that are stored in the storage system and executed by the at least one processor, the at least one modules comprising:
an application module comprising a plurality of parameter groups, each parameter group comprising a plurality of parameter identities;
a communication module comprising:
a management tree comprising a plurality of sub-trees which are constructed correspondingly to the parameter groups, each sub-tree comprising a plurality of parameter identities; and
a communication unit operable to communicate with a server and receive a setting package from the server;
a generation module operable to generate critical parameter groups having all critical parameter identities defined as parameter identities of the sub-tree correlative to each other; and
a determining module operable to determining whether the setting package contains all critical parameter identities of a critical parameter group when the setting package contains at least one critical parameter identity;
wherein if the setting parameter package misses at least one critical parameter identity of the critical parameter group, the communication unit is further operable to wait for the missing critical parameter identities until receive all critical parameter identities of the critical parameter group, the sub-tree corresponding to the critical parameter group and assigns the value of the critical parameter identities to the parameter group of the application module.

2. The WIMAX CPE as claimed in claim 1, further comprising a timer, wherein if the setting package is missing at least one critical parameter identities of the critical parameter group, the timer starts timing and the communication unit waits to receiving the missing critical parameter identities.

3. The WIMAX CPE as claimed in claim 2, wherein if the communication unit does not receive the missing parameter identities until the time is up according to the timer, the communication unit feedbacks a alarm package to the server to notify the server of parameter setting failure.

4. The WIMAX CPE as claimed in claim 1, wherein if the determining module determines the setting package does not contain any critical parameter identity, the management tree assigns the value contained in the setting package to the parameter identities of the parameter group collectively.

5. A method for setting parameter identities of a WIMAX CPE which includes a plurality of parameter groups and a plurality of critical parameter groups correspondingly, each critical parameter group includes a plurality of critical parameter identities correlative to each other, the method comprising:
receiving a setting package from a server;
determining whether the setting package contains critical parameter identities of a critical parameter group;
if the setting package contains critical parameter identities of the critical parameter group, determining whether the setting package contains all critical parameter identities of the critical parameter group;
if the setting package misses at least one critical parameter identities of the critical parameter group, waiting to receiving the missing critical parameter identities until receiving all critical parameter identities of the critical parameter group;
assigning value of the critical parameter identities to the parameter group.

6. The method as claimed in claim 5, wherein if the setting parameter package does not contain any critical parameter identity, assigning value of the setting package to the parameter group.

7. The method as claimed in claim 5, wherein if the setting package does not contain all critical parameter identities of the critical parameter group, starting timing and waiting to receiving the missing critical parameter identities.

8. The method as claimed in claim 7, wherein if does not receive the missing critical parameter identities until timing is up, transmitting an alarm package to the server to notify the server of parameter setting failure.

9. The method as claimed in claim 8, wherein if does not receive the missing critical parameter identities until time is up, transmitting a feedback package indicating the missing critical parameter identities to the server, and requesting the server to transmit the missing critical parameter identities back.

10. A non-transitory storage medium storing a set of instructions, the set of instructions capable of being executed by a processor to perform a method for setting parameter identities of a WIMAX CPE which includes a plurality of parameter groups and a plurality of critical parameter groups correspondingly, each critical parameter group includes a plurality of critical parameter identities correlative to each other, the non-transitory storage comprising:
receiving a setting package from a server;
determining whether the setting package contains critical parameter identities of a critical parameter group;
if the setting package contains critical parameter identities of the critical parameter group, determining whether the setting package contains all critical parameter identities of the critical parameter group;
if the setting package misses at least one critical parameter identities of the critical parameter group, waiting to receiving the missing critical parameter identities until receiving all critical parameter identities of the critical parameter group;
assigning value of the critical parameter identities to the parameter group.

11. The non-transitory storage medium as claimed in claim 10, wherein if the setting parameter package does not contain any critical parameter identity, assigning value of the setting package to the parameter group.

12. The non-transitory storage medium as claimed in claim 10, wherein if the setting package does not contain all critical parameter identities of the critical parameter group, starting timing and waiting to receiving the missing critical parameter identities.

13. The non-transitory storage medium as claimed in claim 12, wherein if does not receive the missing critical parameter identities until timing is up, transmitting an alarm package to the server to notify the server of parameter setting failure.

14. The non-transitory storage medium as claimed in claim 13, wherein if does not receive the missing critical parameter identities until time is up, transmitting a feedback package indicating the missing critical parameter identities to the server, and requesting the server to transmit the missing critical parameter identities back.
